(19) United States
(12) Patent Application Publication
(10) Pub. No.: US 2005/0085586 A1
(43) Pub. Date: Apr. 21, 2005

(54) Coating system for flexible extrusions

(76) Inventors: Daniel F E Sydes, Lancashire (GB); Andrew J Grolys, Staffordshire (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/499,562

(22) PCT Filed: Dec. 20, 2002
(86) PCT No.: PCT/GB02/05876

(30) Foreign Application Priority Data
Dec. 20, 2001 (GB) 0130501.0

(51) Int. Cl. C08K 3/00

(52) U.S. Cl. 524/589

(57) ABSTRACT

A sealing system for automotives comprising a coating formulation applied to a flexible thermoplastics extrusion wherein the coating formulation comprises a UV curable resin.

The present invention is concerned with coating systems for flexible extrusions, specifically thermoplastics extrusions which are used as seals, for example, in the automotive industry.

Automotive sealing systems are manufactured from a range of synthetic rubbers and manufactured thermoplastic materials, generally by extrusion. The most common synthetic rubber is EPDM (Ethylene Propylene Diene Monomer) while the thermoplastics tend to be Thermoplastic Elastomers (TPEs), Thermoplastic Olefins (TPOs) or Thermoplastic Vulcanisate (CPVs). Whether they are to form glass-run channels, weatherstrip or belt-line seals, they all require a coating to be applied to their surface in order to improve the mechanical, chemical and physical properties of the seal.

Presently, the coating systems used are based upon polyester flocculated fibres, polyurethane or silicone resin systems or combinations thereof. The polyester flocculated fibres are bonded to the seal surface by means of a heat-activated adhesive.

The polyurethane and silicone resin materials can be dispersions and/or solutions in deionised water or organic solvent blends. These resins are typically crosslinked, usually employing isocyanate monomers to develop the physical and mechanical properties of the cured coatings.

The lubricant species utilised within the present coatings are primarily either PTFE (PolyTetraFluoroEthylene) or silicone, supplied in dispersion, solution or micropowder form.

The coating formulations are applied by conventional spray, brushing, wiping and dipping techniques. The cure activation mechanism is physical heating of the seal component via combinations of either hot air, IR (light frequency) and or UHF (particle frequency), and is provided by tunnel ovens, of between 10 to 40 metres in length. The cure time for these existing coating systems are typically between 1 and 15 minutes, depending upon the oven facilities available.

It is an object of the present invention to provide a coating system for a flexible extrusion which does not require a long curing time and which can therefore avoid the use of lengthy tunnel ovens.

According to the invention, there is provided a coating formulation for a flexible thermoplastic extrusion, the coating formulation which comprises a curable resin and optionally, a solvent or dispersant for the resin, and in which the resin is a UV curable resin. Preferably the resin is a PUD (polyurethane dispersion) and the solvent/dispersant is water. The formulation preferably includes a photoinitiator, a cross-linking agent and preferably also a friction-reducing agent.

Preferably the PUD is a aliphatic waterborne resin or a mixture of such resins.

Examples include Neorad R440, Neorez R600 of which a mixture of both is particularly preferred.

Suitable photoinitiators include Irgacure 184 and others. A preferred photoinitiator might be 1-[4-(2-Hydroxyethoxy)-phenyl]-2-hydroxy-2-methyl-1-propane-1-one (Irgacure 2959). This cross-linking agent activates the cross-linking of the PUD dispersion when, exposed to UV light of 200-400 nm (UVA, UVB and UVC) to form a dry, flexible film bonding it to the substrate.

The friction-reducing agent is preferably PTFE, which is preferably in the form of a micropowder which has an average particle size of 8 μm. A particularly preferred friction-reducing agent is Fomblin FE20 EG, an aqueous microemulsion based on perfluoropolyether.

The formulation may also include one or more wetting agents, surfactants and pigments. Suitable wetting agents include i.) Silicone polyester acrylate Tegorad 2200N, Slip and Flow additive, ii.) Polyether siloxane copolymer Tegoglide 450.

Suitable surfactants include FC430, Zonyl FSG, Tinuvin 292, Tinuvin 1130 and Tinuvin 144.

The PUD may represent from 40 to 80 wt %, preferably 60 to 80 wt %, more preferably 40 wt % of the formulation, excluding the solvent/dispersant.

The photoinitiator may represent 1 to 5 wt %, preferably 3 to 5 wt %, more preferably 3 wt % of the formulation, excluding the solvent/dispersant.

The friction reducing agent may represent 5 to 30 wt %, preferably 10 to 25 wt %, more preferably 10 wt % of the formulation, excluding the solvent/dispersant.

The PUD may be present in the solvent/dispersant in a concentration of from 38 to 32 wt %, preferably 40 to 41 wt %, for example NeoRad R440 or NeoRez R600 (aliphatic waterborne urethanes manufactured by NeoResins) of which a mixture of both is particularly preferred.

The formulation may be applied to the extruded product continuously, on extrusion, or may be applied to the product after forming to shape. It may be applied by any suitable method, eg. by application by hand spray and automated spray application, brushing, wiping, dipping.

Suitable UV sources included WVA 315400 nm, UVB 280-315 nm, WVC 200-280 nm. A preferred source is UV A, B, C. Curing of the resin may take from 1 to 2 seconds but typically, full curing may take less than 1 second. Furthermore, curing may be effected at ambient temperatures. Thus the system of the invention substantially reduces the cure oven length and cure time and allows the formation of a tough, flexible, low friction film by curing the coating in <1 second, compared to traditional curing requirements of 1-15 mins@ between 150-180° C. The coating may have coefficient of dynamic friction value <0.9, and a coefficient of static friction value <0.9, and its properties include good solvent resistance, flexibility, water resistance, freeze-release properties, heat and humidity resistance. It may be applied to extruded profiles made from Thermoplastic Elastomers (TPE), Thermoplastic olefins (TPO) and Thermoplastic Vulcanisates (TPV). Preferably, the coating is applied to a TPE extruded substrate.

In a particularly preferred form, the invention provides a formulation which combines the use of a perfluropolyether with a UV curable waterborne PUD resin based system, suitable for application by spraying, brushing, wiping, dipping etc., that, when applied onto the aforementioned substrates, offers a flexible film with elasticity of >100%, preferably 120% or even 150%, in extension, whilst retaining the mechanical and chemical resistant properties outlined above. In contrast, existing UV cured coatings are limited to applications where elasticity of the coating film is not required, and in many cases avoided. The present invention is capable of formulating a tough, but highly flexible UV cured coating having repeatable flexibility for application on dynamic sealing systems applications, across a wide range of substrates.

In a preferred embodiment, the present invention provides a coating formulation which has application in sealing systems where the aim is to provide a seal having a coating which retains its flexibilty through repeated flexing and deformation of the seal. This high degree of repeatable flexibility of the coating is of particular importance in “weatherstrip” seals, which include, inter alia, automotive door, bonnet (hood) and boot (trunk) seals, that are exposed to repeated structural compression and release.

The present invention exhibits various further advantages. As continuing environmental assessments are forcing lower VOC limits, the TV coatings of the present invention have low or zero solvent emissions, either by using water as the solvent/dispersant or by using a 100% monomer system.

The formulation can be provided as a 1-pack spray applied system, which has increased pot-life compared to a 2 pack cross-linked coating, as used in prior art systems. Online set up waste is greatly reduced, coating inspection/thickness measurement can be measured seconds after curing compared to 3 minutes curing time for conventional curing, greatly reducing coating and substrate waste.

Smaller production facilities are required. Current state of the art systems employ tunnel ovens with a typical length of between 10 and 40 metres. The present invention requires a two metre long enclosed light source, thereby reducing extrusion line lengths by a factor of, at least, 5. The system may also result in lower energy costs compared to convention, IR or microwave curing ovens. New equipment can easily be fitted to existing production lines.

The recent increase in environmental awareness has resulted in a trend towards a greater use of recyclable materials. This trend is particularly evident in the automotive industry where there is pressure being placed on manufacturers to replace rubber and plastics applications with recyclable materials. The present invention provides a further advantage in that the coating formulations have application in the coating of thermoplastic materials which can be recycled.

The invention may also allow increased use of TPE's, polymers which combine the service properties of elastomers with the processing properties of thermoplastics, as the substrate material in the future. These include:
i.) Blends of rubbers with thermoplastics (EPDM and Polypropylene (PP) and Natural rubber/Polypropylene (NR/PP))
ii.) Soft block copolymers
iii.) Hard block copolymers

Temperature sensitive materials such as TpEs, TpVs and TPOs require low temperature curing at about 100° C. to prevent distortion of their surface or mechanical properties. This is presently achieved by using a catalysed cross-linked system. There are Health & Safety issues with organotin catalysts used. However, UV curing is carried out at ambient temperatures resulting in a substrate temperature of about 40° C which does not result in any obvious alteration or distortion of the surface or mechanical properties of the substrate. This UV curing process can be designed with no temperature increase associated with the curing process (cold-cured systems) if required.

The invention may be carried into practice in various ways and some embodiments will now be illustrated in the following examples.

### EXAMPLE 1

An EPDM extruded substrate was subjected to a pre-treatment consisting of the application of a solvent-based primer. A formulation X was made up by mixing:

| | % |
|---|---|
| PUD (NeoRad R-440) | 60.0 (40% solids) |
| PUD (NeoRez R-600) | 20.0 (40% solids) |
| Fluorinated polyether | 10.0 |
| Photoinitiator A or B (see below) | 3.0 (equates to 40% solution) |
| N-methyl-2-pyrrolidone (NMP) | 4.0 |
| Wetting agents | 3.0 |

The formulation X was applied to an off-line sample of the substrate to a WFT (wet film thickness) of 15-20μ. Water was removed by heating for 2 minutes at 120 to 150° C. UV curing was then effected by exposure to a UVA, UVB, UVC mercury lamp UV source for 1.0 second. The coating was found to have a DFF (day film thickness) of about 15μ. It was well adhered and resistant to abrasion while remaining flexible and of low friction.
Photoinitiators

A. Coating contains 2 photoinitiators (Irgacure 184: Irgacure 819) in a [1:1] mixing (w/w/):

Irgacure 184

CAS 947-19-3

1-Hydroxy-cyclohexyl-phenyl-ketone 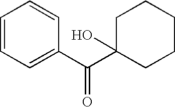
Irgacure 819
CAS 162881-26-7
BIS (2,4,6-trimethylbenzoyl)-phenylphosphineoxide 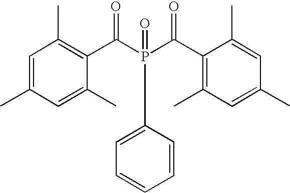
B. Coating contains one photoinitiator (Irgacure 2959):
Irgacure 2959
CAS 106797-53-9
1-[4(2-Hydroxyethoxy)-phenyl-2-hydroxy-2-methyl-1-propane-1-one

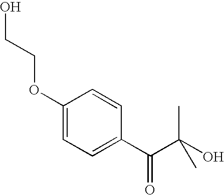

### EXAMPLE 2

A TPE extrusion was pretreated by corona discharge on leaving the extruder and then sprayed with a formulation X (See Example 1 for details). The formulation was sprayed to a WFF of 15-20μ. The extruded substrate had an inherent temperature of about 100° C. and so no separate water removal was necessary. The sprayed substrate was exposed to the same UV source at a speed of 10 to 20 in/min. This produced a fully cured coating with a DFr of about 15μ after less than 1 second exposure to the UV source.

The UV Process

As UV light energy is emitted, it is absorbed by the photoinitiator in the mobile coating (the “wet” coating film), causing it to fragment into reactive species (free radicals). Free radicals react with the unsaturated compounds in the liquid formulation, resulting in polymerisation.

Mechanism (applies to all photoinitiators)

Steps

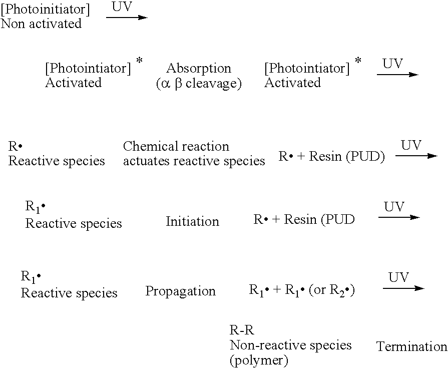

1. A sealing system for automotives comprising a coating formulation applied to a flexible thermoplastics extrusion wherein the coating formulation comprises a UV curable resin.

2. A sealing system as claimed in claim 1, wherein the extrusion is a Thermoplastic Elastomer (TPE) extrusion.

3. A sealing system as claimed in claim 1, wherein the extrusion is a weatherstrip seal.

4. A sealing system as claimed in claim 1, wherein the resin is an aliphatic waterborne resin.

5. A sealing system as claimed in claim 4, wherein the resin is a polyurethane dispersion (PUD).

6. A sealing system as claimed in claim 1, further comprising a solvent or dispersant for the resin.

7. A sealing system as claimed in claim 6, wherein the solvent or dispersant is water.

8. A sealing system as claimed in claim 1, wherein the formulation includes a friction-reducing agent.

9. A sealing system as claimed in claim 6, wherein the resin represents from 40 to 80 wt % of the formulation excluding the solvent or dispersant.

10. The use of a coating formulation comprising a UV curable resin in coating a flexible thermoplastics extrusion.

11. The use as claimed in claim 10, wherein the extrusion is a Thermoplastic Elastomer (TPE) extrusion.

12. The use as claimed in claim 11, wherein the extrusion is a weatherstrip seal.

13. A method of coating a flexible thermoplastics extrusion, the method comprising providing a coating formulation comprising a UV curable resin, applying the composition to a flexible extruded product and exposing the coated product to UV light of 200-400 nm.

14. A coating formulation for a flexible thermoplastics extrusion comprising a UV curable waterborne resin and a water solvent or dispersant for said resin.
